(19) United States
(12) Patent Application Publication
(10) Pub. No.: US 2025/0166480 A1
(43) Pub. Date: May 22, 2025

(54) ALERT SYSTEM FOR A STORE

(71) Applicant: Anas Afaneh, Etobicoke (CA)

(72) Inventor: Anas Afaneh, Etobicoke (CA)

(21) Appl. No.: 18/512,532

(22) Filed: Nov. 17, 2023

(51) Int. Cl. G08B 21/18; B62B 3/00; B62B 5/00; B62B 5/04; G08B 5/36; G08B 6/00

(52) U.S. Cl. CPC G08B 21/18; B62B 3/002; B62B 5/0006; B62B 5/0404; G08B 5/36; G08B 6/00; B62B 2501/00

(57) ABSTRACT

An alert system for a store is disclosed. The alert system is configured to notify a customer about at least one alert condition inside the store. The alert system includes a vibrator adapted to be coupled to a shopping cart and a controller arranged in communication with the vibrator and configured to actuate the vibrator in response to a determination of the at least one alert condition inside the store.

### BACKGROUND

### 1. Technical Field

The present disclosure relates, generally, to a shopping cart, more particularly to a shopping cart assembly including an alert system suitable to alert a user.

### 2. Description of the Prior Art

In recent years, the retail industry has seen a significant shift towards providing customers with a seamless and enjoyable shopping experience. The customers have increasingly adopted various personal audio devices, such as Air pods and Galaxy Buds, to listen to music, podcasts, or other content while shopping. However, relying on these personal audio devices may cause customers to miss important store announcements, leading to potential inconveniences or safety concerns.

Moreover, traditional methods of store announcements, such as intercom systems or overhead announcements, might not effectively reach customers who are engaged with their personal audio devices or are in areas with poor sound coverage. As a result, the customers may miss crucial information like store closing times, emergency alerts, or other time-sensitive announcements. This leads to frustration, confusion, or even unsafe situations, especially during emergencies when prompt action is necessary.

### SUMMARY

One aspect of this disclosure relates to an alert system for a store. The alert system is configured to notify a customer about at least one alert condition inside the store. The alert system includes a vibrator adapted to be coupled to a shopping cart and a controller arranged in communication with the vibrator and configured to actuate the vibrator in response to a determination of the at least one alert condition inside the store.

In some additional, alternative, or selectively cumulative embodiments, the alert system further includes at least one actuator operatively coupled to a plurality of brakes of the shopping cart. The controller is configured to actuate the at least one actuator to apply the plurality of brakes in response to the determination of the at least one alert condition inside the store.

In some additional, alternative, or selectively cumulative embodiments, the alert system further includes a visual indicator adapted to be mounted on the shopping cart and communicatively coupled to the controller. The visual indicator is configured to provide a visual alert to the customer upon determination of the at least one alert condition inside the store.

In some additional, alternative, or selectively cumulative embodiments, the alert system further includes at least one emergency switch adapted to be operated by a store operator in response to occurrence of the least one alert condition and at least one sensor configured to determine a position or actuation of the at least one emergency switch. The controller is configured to determine the at least one alert condition inside the store based on input received from the at least one sensor.

In some additional, alternative, or selectively cumulative embodiments, the controller is arranged in communication with at least one alarm system of the store and determines the at least one alert condition inside the store based on input received from the at least one alarm system.

In accordance with an embodiment of the disclosure, a shopping cart assembly for a store is disclosed. The shopping cart assembly includes a shopping cart, a vibrator coupled to the shopping cart, and a controller arranged in communication with the vibrator and configured to actuate the vibrator in response to a determination of at least one alert condition inside the store.

In some additional, alternative, or selectively cumulative embodiments, the shopping cart includes a plurality of wheels to enable a movement of the shopping cart on a surface, a plurality of brakes to apply a braking on the plurality of wheels, and at least one actuator operatively coupled to the plurality of brakes to enable the braking on the plurality of wheels.

In some additional, alternative, or selectively cumulative embodiments, the controller is arranged in communication with the at least one actuator to apply the braking in response to the determination of the at least one alert condition inside the store.

In some additional, alternative, or selectively cumulative embodiments, the shopping cart assembly further includes a visual indicator mounted on the shopping cart and communicatively coupled to the controller. The visual indicator is configured to provide a visual alert to the customer upon determination of the at least one alert condition inside the store.

In some additional, alternative, or selectively cumulative embodiments, the shopping cart assembly further includes at least one emergency switch adapted to be operated by a store operator in response to occurrence of the least one alert condition and at least one sensor configured to determine a position or actuation of the at least one emergency switch. The controller is configured to determine the at least one alert condition inside the store based on input received from the at least one sensor.

In some additional, alternative, or selectively cumulative embodiments, the controller is arranged in communication with at least one alarm system of the store and determines the at least one alert condition inside the store based on input received from the at least one alarm system.

### BRIEF DESCRIPTION OF THE DRAWINGS

FIG. 1 illustrates a perspective view of a shopping cart assembly having a shopping cart and an alert system, in accordance with an embodiment of the disclosure; and

FIG. 2 illustrates a block diagram of a store having the shopping cart assembly, in accordance with an embodiment of the disclosure.

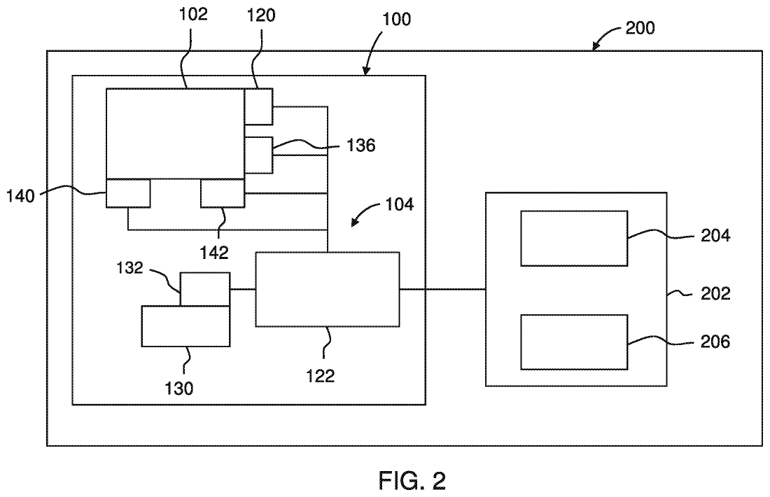

### DETAILED DESCRIPTION

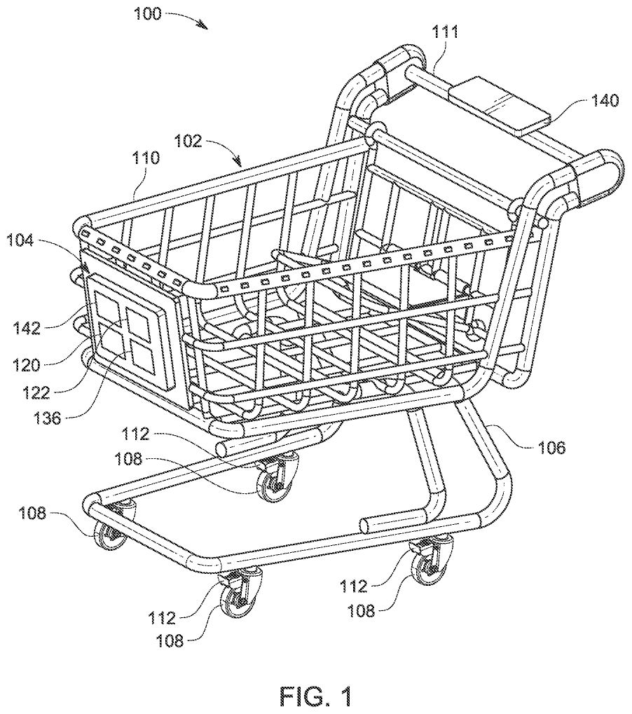

Referring to FIG. 1, a shopping cart assembly 100 including a shopping cart 102 and an alert system 104 and adapted to be utilized in a store 200 is shown. The shopping cart 102 (hereinafter referred to as cart 102) is preferably used by a customer in a shopping mall or a shop for collecting at least one article while shopping inside the store 200. The cart 102 includes a frame 106 supported on a plurality of wheels 108 (i.e., four wheels), a basket 110 supported on the frame 106 to hold goods, and a handle 111 attached to the frame 106 and adapted to be held and pushed by the customer to facilitate movement of the cart 102 on a surface. Further, the cart 102 includes a plurality of brakes 112 operatively coupled with the plurality of wheels 108 and configured to be removably engaged with the plurality of wheels 108 to enable a braking of the cart 102.

Further, the alert system 104 is configured to detect at least one alert condition inside the store 200 and notify the customer about the at least one alert condition. As shown, the alert system 104 includes a vibrator 120 and a controller 122 configured to control/actuate the vibrator 120. The vibrator 120 is attached to the cart 102 and is adapted to vibrate to notify the user upon determination of the at least one alert condition inside the store 200. In an embodiment, the at least one alert condition includes an emergency condition and/or an impending closing of a door of the store 200.

The controller 122 is configured to actuate the vibrator 120 in response to a determination of the at least one alert condition, for example, an emergency situation, a closing of the store 200, etc. In the illustrated embodiment, the controller 122 is shown to be mounted on the cart 102. However, it may be appreciated that the controller 122 may be arranged remotely from the cart 102.

In some embodiments, the store 200 may include at least one alarm system 202 configured to be actuated automatically based on detection of one or more parameters, and/or a switch adapted to be operated by a store operator. For example, the at least one alarm system 202 may include a fire alarm system 204 adapted to generate an alarm upon detection of a fire or smoke inside the store 200. In some embodiments, the at least one alarm system 202 may include a store closing alarm system 206 configured to generate one or more alarms, for example, audio alarms, to notify the customer inside the store 200 about impending closing of the door. In an embodiment, the store closing alarm system 206 may generate alarms based on a closing time of the store 200 or upon actuation of the switch by the store operator. Although the at least one alarm system 202 is shown and contemplated as the fire alarm system 204 and/or the door closing alarm system 206, the store 200 may include any other type of alarm system known in the art and configured to notify the people inside the store 200 about the emergency or alarming situation inside the store 200.

Accordingly, the controller 122 is arranged in communication with the at least one alarm system 202 and is configured to actuate the vibrator 120 based on the actuation of the at least one alarm system 202 of the store 200. In some embodiments, the alert system 104 may include at least one sensor configured to detect an actuation of the at least one alarm system 202 of the store 200.

Further, in some embodiments, the alert system 104 may include at least one emergency switch 130 adapted to be operated by the store operator to inform or notify the customers present inside the store 200 about the at least one alert condition inside the store 200. In such a case, the alert system 104 may include at least one sensor 132 configured to determine a position or an actuation of the at least one emergency switch 130 and share an input regarding the position or actuation of the at least one emergency switch 130 to the controller 122. Upon determination of the position or actuation of the emergency switch 130, the controller 122 is configured to actuate the vibrator 120 to generate vibration, and vibrate the cart 102 to notify the customer holding the cart 102 about the emergency situation and/or closing of the store 200.

Additionally, or optionally, the controller 122 is configured to actuate the plurality of brakes 112 of the cart 102 upon or along with the actuation of the vibrator 120 to immobilize the cart 102. For so doing, the shopping cart assembly 100 (i.e., cart 102 or the alert system 104) may include at least one actuator 136 operatively coupled to the plurality of brakes 112 and adapted to be actuated by the controller 122 to apply the brakes of the cart 102.

Moreover, in some embodiments, the alert system 104 may include at least one visual indicator 140, for example an LED display or a light, arranged in communication with the controller 122 and configured to provide a visual alert/alarm to the user of the cart 102 in response to generation of the at least one alert condition. For example, the visual indicator 140 may include the LED display to display the emergency alert and provide notification to the customer to head to nearby exit of the store 200. In some embodiments, the at least one visual indicator 140 may include a light unit configured to be actuated by the controller 122 in response to determination of the at least one alert condition inside the store 200. In some embodiments, the alert system 104 may include a locator 142 configured to determine a location of the cart 102 inside the store 200. The locator 142 is arranged in communication with the controller 122, and the controller 122 is configured to display the cart 102 on a map of the store 200 and display a route to nearest exit of the store 200 on the LED display based on input from the locator 142 upon determination of the at least one alert condition inside the store 200.

It should be understood that the foregoing description is only illustrative of the aspects of the disclosed embodiments. Various alternatives and modifications can be devised by those skilled in the art without departing from the aspects of the disclosed embodiments.

What is claimed is:

1. An alert system for a store and configured to notify a customer about at least one alert condition inside the store, the alert system comprising:
a vibrator adapted to be coupled to a shopping cart; and
a controller arranged in communication with the vibrator and configured to actuate the vibrator in response to a determination of the at least one alert condition inside the store.

2. The alert system of claim 1 further including at least one actuator operatively coupled to a plurality of brakes of the shopping cart, wherein the controller is configured to actuate the at least one actuator to apply the plurality of brakes in response to the determination of the at least one alert condition inside the store.

3. The alert system of claim 1 further including a visual indicator adapted to be mounted on the shopping cart and communicatively coupled to the controller, wherein the visual indicator is configured to provide a visual alert to the customer upon determination of the at least one alert condition inside the store.

4. The alert system of claim 1 further including
at least one emergency switch adapted to be operated by a store operator in response to occurrence of the least one alert condition, and
at least one sensor configured to determine a position or actuation of the at least one emergency switch, wherein
the controller is configured to determine the at least one alert condition inside the store based on input received from the at least one sensor.

5. The alert system of claim 1, wherein the controller is arranged in communication with at least one alarm system of the store and determines the at least one alert condition inside the store based on input received from the at least one alarm system.

6. A shopping cart assembly for a store, comprising:
a shopping cart;
a vibrator coupled to the shopping cart; and
a controller arranged in communication with the vibrator and configured to actuate the vibrator in response to a determination of at least one alert condition inside the store.

7. The shopping cart assembly of claim 6, wherein the shopping cart includes
a plurality of wheels to enable a movement of the shopping cart on a surface,
a plurality of brakes to apply a braking on the plurality of wheels, and
at least one actuator operatively coupled to the plurality of brakes to enable the braking on the plurality of wheels.

8. The shopping cart assembly of claim 7, wherein the controller is arranged in communication with the at least one actuator to apply the braking in response to the determination of the at least one alert condition inside the store.

9. The shopping cart assembly of claim 6 further including a visual indicator mounted on the shopping cart and communicatively coupled to the controller, wherein the visual indicator is configured to provide a visual alert to the customer upon determination of the at least one alert condition inside the store.

10. The shopping cart assembly of claim 6 further including
at least one emergency switch adapted to be operated by a store operator in response to occurrence of the least one alert condition, and
at least one sensor configured to determine a position or actuation of the at least one emergency switch, wherein
the controller is configured to determine the at least one alert condition inside the store based on input received from the at least one sensor.

11. The shopping cart assembly of claim 6, wherein the controller is arranged in communication with at least one alarm system of the store and determines the at least one alert condition inside the store based on input received from the at least one alarm system.
